(19) United States
(12) Patent Application Publication
(10) Pub. No.: US 2025/0288908 A1
(43) Pub. Date: Sep. 18, 2025

(54) METHOD AND APPARATUS FOR PROVIDING GAME SERVICE

(71) Applicant: NEXON KOREA CORPORATION, Seongnam-si (KR)

(72) Inventor: Jeong Soo KIM, Seongnam-si (KR)

(21) Appl. No.: 19/076,580

(22) Filed: Mar. 11, 2025

(30) Foreign Application Priority Data
Mar. 12, 2024 (KR) 10-2024-0034745

(51) Int. Cl. A63F 13/537; A63F 13/69

(52) U.S. Cl. CPC A63F 13/537; A63F 13/69

(57) ABSTRACT

The method of providing the game service includes determining a second reward quantity representing a quantity of the first item to be provided in a second reward cycle for the content based on the first reward quantity and a quantity of the first item provided in the first reward cycle. The method of providing the game service includes determining a second reward quantity representing a quantity of the first item that is to be provided in a second reward cycle for the content based on the first reward quantity and the quantity of the first item provided in the first reward cycle. The method of providing the game service includes providing a first item in a second reward cycle for the content according to the second reward quantity.

### CROSS-REFERENCE TO RELATED APPLICATION

This application is based on and claims priority under 35 U.S.C. § 119 to Korean Patent Application No. 10-2024-0034745, filed on Mar. 12, 2024, in the Korean Intellectual Property Office, the disclosure of which is incorporated by reference herein in its entirety.

### BACKGROUND

### Technical Field

The disclosure relates to a method and apparatus for providing a game service, and more particularly, to a method and apparatus related to providing a reward to a user who performs content within a game service.

### Description of the Related Art

Recently, many games of various genres have been developed, which has leaded to an explosive increase in users. As games of various genres are developed and the performance of devices used to enjoy games improves, games have emerged as a mainstream hobby.

Game industry has introduced various systems related to game items to enable development of various game strategies utilizing the game items. For example, an in-game user is capable of performing various in-game contents that provide necessary game items to obtain the necessary game items. A reward for content may be provided in various ways by changing an in-game environment, and thus may provide new fun to players and encourage their desire to grow.

### BRIEF SUMMARY

Provided is a method and apparatus for providing a game service, which diversifies a method of providing a reward to a user who performs content within the game service.

Additional aspects will be set forth in part in the description which follows and, in part, will be apparent from the description, or may be learned by practice of the presented embodiments of the disclosure.

According to an aspect of the disclosure, a method of providing a game service by a game providing apparatus is provided. A method of providing a game service may include determining a first reward quantity representing a quantity of a first item to be provided in a first reward cycle for content within the game service. The method of providing the game service may include determining a second reward quantity representing a quantity of the first item to be provided in a second reward cycle for the content based on the first reward quantity and the quantity of the first item provided in the first reward cycle. The method of providing the game service may include providing a first item in a second reward cycle for the content according to the second reward quantity.

According to another aspect of the disclosure, a game providing apparatus includes memory storing instructions, and at least one processor functionally connected to the memory and configured to execute the instructions. The at least one processor may be configured to execute instructions to determine a first reward quantity representing a quantity of the first item that is to be provided in a first reward cycle for content within the game service. The at least one processor may be configured to determine a second reward quantity representing a quantity of the first item that is to be provided in a second reward cycle for content based on the first reward quantity and the quantity of the first item provided in the first reward cycle. The at least one processor may be configured to provide the first item in the second reward cycle for the content, depending on the second reward quantity.

According to another aspect of the disclosure, a server includes memory storing instructions, and at least one processor functionally connected to the memory and configured to execute the instructions. The at least one processor may be configured to execute instructions to determine a first reward quantity representing a quantity of the first item that is to be provided in a first reward cycle for content within the game service. The at least one processor may be configured to determine a second reward quantity representing a quantity of the first item that is to be provided in a second reward cycle for content based on the first reward quantity and the quantity of the first item provided in the first reward cycle. The at least one processor may be configured to provide the first item in the second reward cycle for the content, depending on the second reward quantity.

According to another aspect of the disclosure, a user terminal includes memory storing instructions, and at least one processor functionally connected to the memory and configured to execute the instructions. The at least one processor may be configured to execute instructions to determine a first reward quantity representing a quantity of the first item that is to be provided in a first reward cycle for content within the game service. The at least one processor may be configured to determine a second reward quantity representing a quantity of the first item that is to be provided in a second reward cycle for content based on the first reward quantity and the quantity of the first item provided in the first reward cycle. The at least one processor may be configured to provide the first item in the second reward cycle for the content, depending on the second reward quantity.

According to another aspect of the disclosure, a computer-readable recording medium having recorded thereon a program for performing the method of providing the game service is provided. The method of providing the game service may include determining a first reward quantity representing a quantity of a first item to be provided in a first reward cycle for content within the game service. The method of providing the game service may include determining a second reward quantity representing a quantity of the first item that is to be provided in a second reward cycle for the content based on the first reward quantity and the quantity of the first item provided in the first reward cycle. The method of providing the game service may include providing a first item in a second reward cycle for the content according to the second reward quantity.

### BRIEF DESCRIPTION OF THE SEVERAL VIEWS OF THE DRAWINGS

The above and other aspects, features, and advantages of certain embodiments of the disclosure will be more apparent from the following description taken in conjunction with the accompanying drawings, in which:

FIG. 1 illustrates a game providing system including a server and a user terminal according to various embodiments;

FIG. 2 is a conceptual diagram illustrating a reward stack according to an embodiment;

FIG. 3 is a conceptual diagram illustrating reward rotation according to an embodiment;

FIG. 4 is a flowchart illustrating a method of providing a game service according to an embodiment;

FIG. 5A is a diagram illustrating a reward interface according to an embodiment;

FIG. 5B is a diagram illustrating a reward interface according to an embodiment;

FIG. 6 is a diagram illustrating a reward interface according to an embodiment;

FIG. 7 is a diagram illustrating a reward interface according to an embodiment;

FIG. 8 is a diagram for explaining an operation of providing detailed information about an item according to an embodiment;

FIG. 9 is a diagram illustrating a settlement interface according to an embodiment;

FIG. 10 is a diagram illustrating a settlement interface according to an embodiment;

FIG. 11 is a diagram illustrating a settlement interface according to an embodiment;

FIG. 12 is a diagram for explaining a detailed configuration of a game providing apparatus according to an embodiment;

FIG. 13 is a diagram for explaining a detailed configuration of a server according to an embodiment; and

FIG. 14 is a diagram for explaining a detailed configuration of a user terminal according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the contents described in the accompanying drawings. A method of configuring and using an electronic device according to an embodiment is described in detail with reference to the contents described in the accompanying drawings. The same reference numbers or symbols presented in each drawing represent parts or components that perform substantially the same function.

In the disclosure, the expression “at least one of a, b or c” may refer to “a”, “b”, “c”, “a and b”, “a and c”, “b and c”, “all of a, b and c”, or variations thereof.

Terms that include ordinal numbers, such as first or second may be used to describe various components, but the components are not limited by the terms. Terms are used solely to distinguish one component from another. For example, without departing from the scope of the disclosure, a first component may be named a second component, and similarly, the second component may also be named the first component. The term ‘and/or’ includes any combination of a plurality of related items or any single item from among the plurality of related items.

The terms used herein are used to describe embodiments only and are not intended to limit and/or restrict the disclosure. Singular expressions include plural expressions unless context clearly indicates otherwise. In the specification, it will be understood that the terms such as “comprise (include)” or “have” are intended to specify presence of a feature, number, step, operation, component, part or combination thereof described in the specification but do not exclude the possibility of presence or addition of one or more other features, numbers, steps, operations, components, parts or combinations thereof.

Throughout the specification, when a portion is connected to another portion, this includes not only a case in which the portions are directly connected, but also a case in which the portions are electrically connected with another element in between. When a portion includes a certain component, this does not mean that it excludes other components, unless otherwise specifically stated, but rather that it may include other components. The terms such as “ . . . unit” or “module” described in the specification may mean a unit that processes at least one function or operation and may be embodied in a hardware manner, a software manner, or a combination of the hardware manner and the software manner.

Hereinafter, in the disclosure, a game providing apparatus may be a game server, a user terminal, a game system including a game server and a user terminal, or an independent device.

Hereinafter, in the disclosure, the server controlling the user terminal may mean that the server provides output from the user terminal (all output devices of the user terminal, such as screen display, sound output, vibration output, and lamp lighting) and data for the user terminal to perform a certain operation through communication with the user terminal. The user terminal may control the output from the user terminal by using prestored data, and is not limited to the example.

Hereinafter, in the disclosure, meaning of transmitting and receiving information or data with a user (or user account) may include meaning of transmitting and receiving information or data with a device (or user terminal) corresponding to or linked with the user (or user account).

Hereinafter, in the disclosure, a user, a player, a user account, and a gamer may be used with the same meaning. It needs to be understood that in the disclosure, a user terminal may refer to a user, a player, a user account, a gamer, or a device used by them, depending on the context. It needs to be understood that in the disclosure, a user, a player, a user account, and a gamer may refer to an avatar or character operated by them or to a device used by them, depending on the context.

Hereinafter, in the disclosure, the term ‘game object’ may mean a virtual object existing within a game space. For example, the game object may include, but is not limited to, a user character (e.g., an avatar), and a user item and may also mean any object implemented within a game space, such as a background or terrain.

Hereinafter, in the disclosure, the term ‘character’ may mean a certain object to be controlled by a user within a game.

Hereinafter, in the disclosure, the term ‘game item’ may include all objects, goods, and contents and may mean equipment equipped by an in-game character such as a weapon, an armor, an accessory, clothes, or a crystal, a vehicle ridden by an in-game character, a consumable such as food and potion, an experience point, a buff, all digital contents to be obtained by a user in a game, a cyber object, or the like, but are not limited to the example.

Hereinafter, in the disclosure, the term ‘game goods’ or ‘goods’ may mean goods to be obtained by a user for a fee as currency used or accepted within a game or free of charge. In other words, the game goods may refer to all forms of goods used for trading or purchasing within a game, such as an item or a game count. The game goods may include paid goods and free goods. The game goods may include a plurality of types of goods. The paid goods may include a plurality of types of goods, and the free goods may also include a plurality of types of goods.

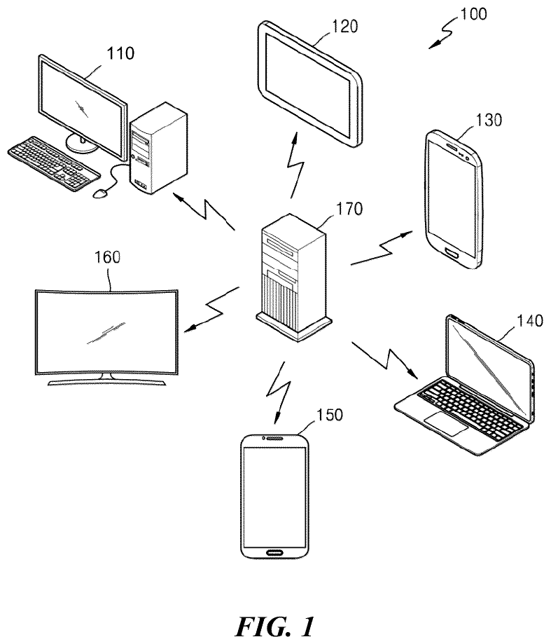

FIG. 1 illustrates a game providing system 100 including a server and a user terminal according to various embodiments.

The game providing system 100 according to the disclosure may include a server 170 and at least one user terminal 110 to 160. The server 170 may provide various online activities to the at least one user terminal 110 to 160 through a network. The server 170 may simultaneously provide an online activity to the at least one user terminal 110 to 160 through a network.

According to an embodiment, the server 170 may include a single server, a server cluster, and a cloud server but is not limited to the example. The server 170 may provide various online activities to the at least one user terminal 110 to 160 and include a database that stores data for online activities of the at least one user terminal 110 to 160. The server 170 may also include a payment server that generates and processes a payment event. As described above, the server 170 may be a game providing apparatus.

According to an embodiment, a network may mean a connection established (or formed) using any communication method and mean a communication network connected via any communication method that transmits and receives data between terminals or between a terminal and a server.

Any communication method may include any communication method, such as communication through a certain communication standard, a certain frequency band, a certain protocol, or a certain channel. For example, any communication method may include a communication method through Bluetooth, Bluetooth low energy (BLE), Wi-Fi, Zigbee, 3-generation (3G), long term evolution (LTE), and ultrasonic and include short-range communication, long-range communication, wireless communication, and wired communication. It may not be limited to the example.

According to an embodiment, a short-range communication method may mean a communication method in which communication is possible only when a device (terminal or server) performing communication is within a certain range and include, for example, Bluetooth and near field communication (NFC). A long-range communication method may refer to a communication method in which a device performing communication is capable of communicating regardless of a distance. For example, the long-range communication method may mean a method in which two devices performing communication through a repeater such as an application processor (AP) are capable of communicating even when the devices are separated by a certain distance or more and include a communication method using a cellular network (3G or LTE) such as a short message service (SMS) and a phone. It may not be limited to the example. Meaning that online activities are provided by using a network may include meaning that communication between a server and a terminal is capable of being performed through any communication method.

Throughout the specification, the at least one user terminal 110 to 160 may include a personal computer 110, a tablet 120, a cellular phone 130, a laptop 140, a smart phone 150, a television (TV) 160, as well as various electronic devices such as personal digital assistants (PDA), a portable multimedia player (PMP), a navigation device, an MP3 player, a digital camera, a refrigerator, a washing machine, and a vacuum cleaner, but is not limited to the example. As described above, the at least one user terminal 110 to 160 may be a game providing apparatus.

According to an embodiment, the online activity may include an online game, a portal service, and a social network service (SNS), but is not limited to the example. The online game may include various genres such as a sport, massively multiplayer online role-playing game (MMORPG), aeon of strife (AOS), frame per second (FPS), trading card game (TCG), and collectable card game (CCG). The online game may be a game in which users compete against each other or a user competes against a computer (e.g., artificial intelligence). The online game may be a blockchain game. The online game may not be limited to the example and there are no restrictions on the form of online games.

According to an embodiment, the game providing apparatus may determine a first reward quantity representing a quantity of a first item that is to be provided in a first reward cycle for content within a game service. The game providing apparatus may determine a second reward quantity representing a quantity of the first item that is to be provided in a second reward cycle for content based on the first reward quantity and the quantity of the first item provided in the first reward cycle. The game providing apparatus may provide the first item in the second reward cycle for the content, depending on the second reward quantity.

According to an embodiment, the game providing system 100 may determine the first reward quantity representing the quantity of the first item that is to be provided in the first reward cycle for content within a game service. The game providing system 100 may determine the second reward quantity representing the quantity of the first item that is to be provided in the second reward cycle for content based on the first reward quantity and the quantity of the first item provided in the first reward cycle. The game providing system 100 may provide the first item in the second reward cycle for content, depending on the second reward quantity.

According to an embodiment, the server 170 may determine the first reward quantity representing the quantity of the first item that is to be provided in the first reward cycle for content within a game service. The server 170 may determine the second reward quantity representing the quantity of the first item that is to be provided in the second reward cycle for content based on the first reward quantity and the quantity of the first item provided in the first reward cycle. The server 170 may provide the first item in the second reward cycle for the content, depending on the second reward quantity.

According to an embodiment, one of the at least one user terminal 110 to 160 may determine the first reward quantity representing the quantity of the first item that is to be provided in the first reward cycle for content within a game service. One of the at least one user terminal 110 to 160 may determine the second reward quantity representing the quantity of the first item that is to be provided in the second reward cycle for content based on the first reward quantity and the quantity of the first item provided in the first reward cycle. One of the at least one user terminal 110 to 160 may provide the first item in the second reward cycle for the content, depending on the second reward quantity.

In an embodiment, some or all of operations of the server 170 may be performed by the user terminals 110 to 160. For example, a method of providing a game service according to an embodiment may be performed by the user terminals 110 to 160 without communication with the server 170.

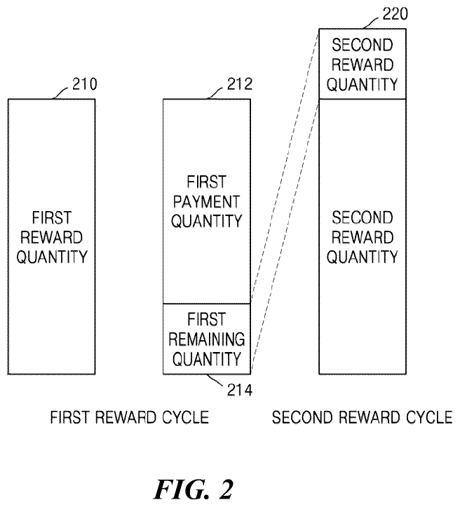

FIG. 2 is a conceptual diagram illustrating a reward stack according to an embodiment.

In an embodiment, a game providing apparatus may provide at least one content within a game service. The content may include anything a user experiences within the game service. For convenience of description, only a reward for one content is described with reference to FIGS. 2 to 4, and the number of contents provided in the game service is not limited to one. The reward may be a compensation or prize that is to be provided to a user as performing certain content and may include a game item or game goods. The reward stack may represent an item providing method in which a quantity of items to be provided in a certain reward cycle affects a quantity of items provided in a subsequent reward cycle.

In an embodiment, the game providing apparatus may provide at least one item in a reward cycle representing a time interval during which a certain reward is provided for content within a game service. The game providing apparatus may provide at least one item in a first reward cycle for content and provide at least one item in a certain quantity.

In an embodiment, the game providing apparatus may determine a first reward quantity 210 representing a quantity of a first item provided in at least one item that is to be provided in the first reward cycle for the content. The game providing apparatus may provide the first item in the first reward cycle for the content, according to the first reward quantity 210.

In an embodiment, the game providing apparatus may determine, as 10, the first reward quantity 210 for the first item that is to be provided in the first reward cycle for the content. The game providing apparatus may provide up to ten first items in the first reward cycle for the content. For example, the game providing apparatus may provide eight first items in the first reward cycle for the content.

In an embodiment, the game providing apparatus may settle the first item at the end of the first reward cycle. The game providing apparatus may determine a second reward quantity 220 representing a quantity of the first item to be provided in the second reward cycle for the content based on the first reward quantity 210 and the quantity of the first item provided in the first reward cycle.

In an embodiment, the game providing apparatus may determine the second reward quantity 220 to be a preset first basic quantity for providing the first item in the second reward cycle. The game providing apparatus may determine the second reward quantity 220 to be a value greater than a preset first basic quantity for providing the first item in the second reward cycle.

In an embodiment, the game providing apparatus may determine the second reward quantity 220 independently of a first payment quantity 212 representing a quantity of the first item provided in the first reward cycle. Alternatively, the game providing apparatus may determine the second reward quantity 220 based on the first reward quantity 210 and the first payment quantity 212.

In an embodiment, the game providing apparatus may determine the second reward quantity 220 to be a preset basic quantity for providing the first item in the second reward cycle. The game providing apparatus may determine the second reward quantity 220 as a preset basic quantity for providing the first item in the second reward cycle when the first payment quantity (212) and the first reward quantity (210) are the same.

In an embodiment, when the first payment quantity 212 is less than the first reward quantity 210, the game providing apparatus may determine the second reward quantity 220 as a value obtained by adding a first remaining quantity 214 representing a difference between the first reward quantity 210 and the first payment quantity 212 to a preset basic quantity for providing the first item in the second reward cycle. The maximum value of the first remaining quantity may be limited.

For example, when the first reward quantity 210 is 10, a preset basic quantity for providing the first item in the second reward cycle is 15, and the first payment quantity 212 is 8, the game providing apparatus may determine the second reward quantity 220 to be 17. When a maximum value of the first remaining quantity 214 is 1, the game providing apparatus may determine the second reward quantity 220 to be 16.

A method of determining the second reward quantity 220 is not limited to the disclosed example. The second reward cycle may be different from the first reward cycle and may be a reward cycle that occurs after the first reward cycle. For example, the second reward cycle may be a cycle that occurs immediately after the first reward cycle ends or may be a cycle that occurs N cycles after the first reward cycle ends.

In an embodiment, when the game providing apparatus provides a reward stack, an expected reward increases the sooner the content is cleared, and thus a player desire to grow may be stimulated, and even for content that is not highly preferred, a player desire to perform the content may be stimulated by rewards accumulating over time, thereby naturally obtaining an effect of activating various contents.

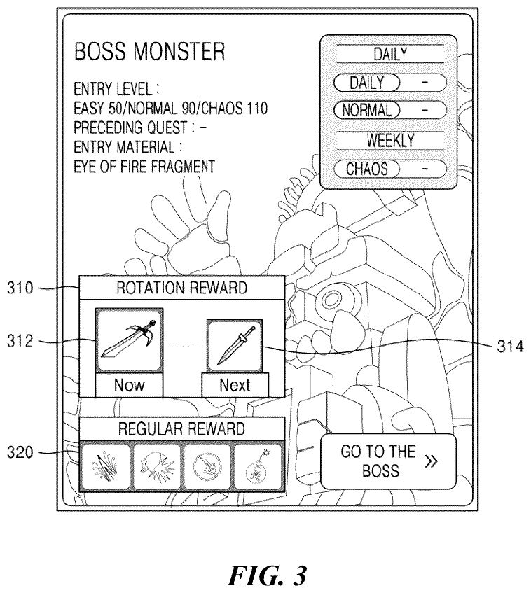

FIG. 3 is a conceptual diagram illustrating reward rotation according to an embodiment.

In an embodiment, the game providing apparatus may provide at least one item as a reward for content within a game service. The game providing apparatus may provide at least one rotational reward item and at least one regular reward item. For example, the rotational reward item may refer to a reward item that changes every reward cycle from among items provided for content. The regular reward item may refer to an item that is regularly recharged and continuously provided for content, regardless of a reward cycle.

In an embodiment, the rotational reward item may be an item with a low drop rate and difficult for a user to obtain through field hunting or the like. For example, the rotational reward item may be an item such as a weapon, armor, jewelry, clothing, and crystal.

In an embodiment, the rotational reward item may be a non-fungible token (NFT). When a game service is a blockchain game, the NFT may be provided as a reward item for in-game content, which may help generate economic benefits for a user, enhance reliability and safety, and encourage the user to participate in the game. The first item and the second item may be the NFT.

In an embodiment, the rotational reward item may be a cosmetic item that is an NFT. A steady supply source for functional equipment and a fungible token (FT) is required because the functional equipment and the FT have independent functions within a game service and are difficult to replace, and thus a game providing apparatus may provide a cosmetic item as the rotational reward item.

In an embodiment, the game providing apparatus may provide the first items in the first reward cycle for the content. The game providing apparatus may provide the second item in a third reward cycle for the content. For example, the game providing apparatus may determine the first item as the rotational reward item to be provided in the first reward cycle for boss hunting. The game providing apparatus may determine the second item as the rotational reward item to be provided in the third reward cycle for boss hunting. The game providing apparatus may provide the first item as the rotational reward item in the first reward cycle for the content. The game providing apparatus may provide the second item as the rotational reward item in the third reward cycle for the content. For convenience of explanation, to distinguish from the second reward cycle in FIG. 2, a reward cycle different from the first reward cycle may be expressed as the third reward cycle in FIG. 3 but is not limited to the disclosed example, and the third reward cycle may be the same as the second reward cycle in FIG. 2.

In an embodiment, when the first reward cycle includes a current point in time, the game providing apparatus may display the first item as the rotational reward item provided in the current reward cycle. When the third reward cycle is a reward cycle after the first reward cycle, the game providing apparatus may display the second item as the rotational reward item provided in a next reward cycle.

In an embodiment, the second item may be the same as or different from the first item. When the second item is the same as the first item, the reward stack of FIG. 2 may be applied. When the second item is different from the first item, a reward quantity for the second item may be determined regardless of the reward stack of FIG. 2 and regardless of the first remaining quantity for the first item.

For convenience of explanation, reward quantities for the first and second items are omitted in FIG. 3. For convenience of explanation, it is explained as an example that there is only one rotational reward item provided in the first reward cycle and one rotational reward item provided in the third reward cycle, but the disclosure is not limited to the disclosed example.

In FIG. 3, the first item and the second item are explained as rotational reward items as an example, but the first item and/or the second item in FIGS. 1 to 2 and FIGS. 4 to 14 are not limited thereto.

In an embodiment, when the game providing apparatus provides reward rotation, some of rewards placed in content are continuously changed, and thus attractiveness of each content felt by a player may change, thereby providing new fun to the player and obtaining an effect of activating various contents.

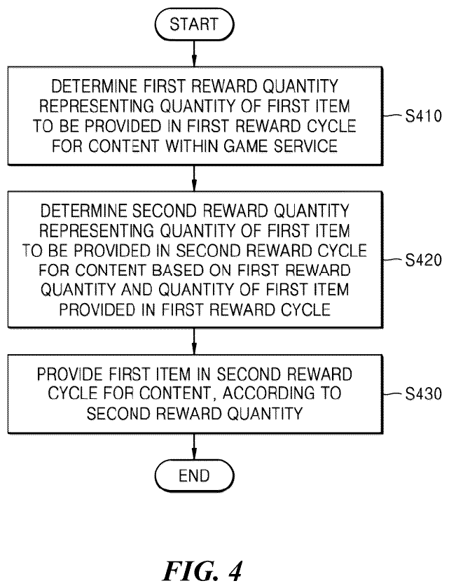

FIG. 4 is a flowchart illustrating a method of providing a game service according to an embodiment.

In operation S410, the game providing apparatus may determine a first reward quantity representing a quantity of the first item to be provided in a first reward cycle for content within the game service.

In an embodiment, a total quantity of first items provided within the game service may be preset. The preset quantity of the first item may not be capable of being changed. The game providing apparatus may determine, as the first reward quantity to be provided in the first reward cycle, at least a portion of the total quantity of the first item. The first item may be a rotational reward item. Alternatively, the first item may be a regular reward item. The first reward quantity may be one or more.

In an embodiment, the first reward quantity may be a preset basic quantity for the first item to be provided in the first reward cycle for a certain content. The first reward quantity may be a quantity obtained by adding a remaining quantity from a previous reward cycle to the preset basic quantity. It is not limited to the disclosed example.

In operation S420, the game providing apparatus may determine a second reward quantity representing a quantity of the first item to be provided in a second reward cycle for content based on the first reward quantity and the quantity of the first item provided in the first reward cycle.

In an embodiment, the game providing apparatus may determine the second reward quantity representing the quantity of the first item to be provided in the second reward cycle for content based on a first reward quantity and a first payment quantity.

In an embodiment, the game providing apparatus may determine the second reward quantity to be a value greater than or equal to a preset basic quantity for providing the first item in the second reward cycle.

In an embodiment, the game providing apparatus may determine the second reward quantity to be a preset basic quantity for providing the first item in the second reward cycle. The game providing apparatus may determine the second reward quantity as a preset basic quantity for providing the first item in the second reward cycle when the first payment quantity and the first reward quantity are the same.

In an embodiment, the game providing apparatus may determine the second reward quantity to be a value greater than the preset basic quantity for providing the first item in the second reward cycle. When the first payment quantity representing the quantity of the first item provided in the first reward cycle is less than the first reward quantity, the game providing apparatus may determine the second reward quantity as a value obtained by adding the first remaining quantity representing a difference between the first reward quantity and the first payment quantity to a preset basic quantity for providing the first item in the second reward cycle.

In operation S430, the game providing apparatus may provide the first item in the second reward cycle for the content, according to the second reward quantity.

In an embodiment, the game providing apparatus may provide the first item in the second reward cycle for the content, according to the determined second reward quantity. The game providing apparatus may provide the first item up to the second reward quantity as a reward for a certain content.

In an embodiment, the game providing apparatus may settle at least one item in each reward cycle. For example, the game providing apparatus may settle the first item at a certain point in time within the first reward cycle as compensation for performing the content. The game providing apparatus may provide the first item to at least one user according to a preset drop rate as compensation for performing content during the first reward cycle.

In an embodiment, when the second reward quantity is fully provided to at least one user during the second reward cycle and is exhausted, the game providing apparatus may stop providing the first item until the second reward cycle ends. When the second reward quantity is exhausted at a certain time within the second reward cycle, the game providing apparatus may stop providing the first item from the certain time until the end of the second reward cycle. When the second reward cycle ends and a next reward cycle different from the second reward cycle starts consecutively, the game providing apparatus may restart providing the first item from the start of the next reward cycle if the first item is provided as an item to be provided in the next reward cycle. In this case, a user who participates in content immediately after the reward is charged may have a high probability of obtaining the item.

In an embodiment, the game providing apparatus may settle the first item at the end of the first reward cycle as compensation for performing the content. The game providing apparatus may determine at least one user to be provided with the first item from among users who perform the content at the end of the second reward cycle. The game providing apparatus may, at the end of the second reward cycle, provide the first item to the users who perform the content through a drawing up to the second reward quantity. In this case, there may not be a distinction between advantages and disadvantages according to the order of participation within a cycle.

In an embodiment, when the second reward quantity is greater than the number of the users who perform the content, the game providing apparatus may provide the first item to all users who perform the content. When the second reward quantity is less than the number of the users who perform the content, the game providing apparatus may determine at least one user who is to be provided with the first item through a drawing, in the second reward quantity, and provide the first item to the determined at least one user.

Without being limited to the disclosed example, the game providing apparatus may provide two or more first items to one user. Without being limited to the disclosed example, whether a certain user is provided with a first item may be determined based on a drop rate for the first item, the number of users who perform content, the number of times a certain user performs the content, and the second reward quantity. For example, as a drop rate increases, the number of users performing content decreases, the number of times a certain user performs the content increases, and the second reward quantity increases, a probability that a certain user is provided with the first item increases.

In an embodiment, when a plurality of users cooperatively perform content, the game providing apparatus may provide the first item to only some of the users. For example, the game providing apparatus may provide the first item to a user who deals with the most monsters from among a plurality of users who cooperate upon completion of content within the second reward cycle. Without being limited to the disclosed example, the game providing apparatus may determine, in another manner, at least one user who is to be provided with the first item from among a plurality of users who cooperatively perform content.

In an embodiment, the game providing apparatus may provide the first item to some of the users who cooperatively perform the content at the end of the second reward cycle for the content. The game providing apparatus may determine some users upon completion of the content or at the end of the second reward cycle. For example, the game providing apparatus may provide the first item to a randomly determined user from among users who perform a party quest at the end of the second reward cycle. However, the game providing apparatus may provide the first item only to some users from among a plurality of users determined from a plurality of parties that perform the party quest.

In an embodiment, the game providing apparatus may further maximize a player desire to grow and perform content by varying a settlement time for the content according to the characteristics of the content. For example, for content that has no limit on the number of participations or content cost, the player may be rewarded immediately after performing the content, thereby providing an immediate reward to the player and motivating the player to continue perform the content. Alternatively, for content with a limited number of participations, the content may be settled at the end of the reward cycle or within a certain time after the end of the reward cycle, thereby encouraging many players to participate in the content up to the maximum number of participations.

In an embodiment, the content may include at least one of field hunting, a dynamic field, boss hunting, an area quest, a party quest, or a growth quest.

In an embodiment, the field hunting may be content of hunting monsters, and the like in a field provided by a game service to obtain items or experience points, or complete quests. The dynamic field may be content related to hunting an upgraded monster other than a regular monster in a field, or content related to a random field or a field in which an access authority is randomly granted in response to satisfying a certain condition. The boss hunting may be content related to hunting a boss monster in a field provided for the boss monster in a game service.

In an embodiment, the area quest may be content related to an area or location related to at least one map that shares story connectivity or background similarity within the game service. The party quest may be content that provides a mission that a plurality of users need to complete together. The growth quest may be content that provides a mission to be performed in stages according to a difficulty level.

In an embodiment, content may be provided in a unit of any one of a map, a reward layer, and a set of reward layers. The reward layer may be a functional group that shares a reward, may include at least some of themes that share story connectivity or background similarity, and may include at least one map. The set of reward layers may include at least one reward layer. The set of reward layers may include at least one reward layer belonging to a theme that shares story connectivity or background similarity. The set of reward layers may include at least one reward layer according to a level range.

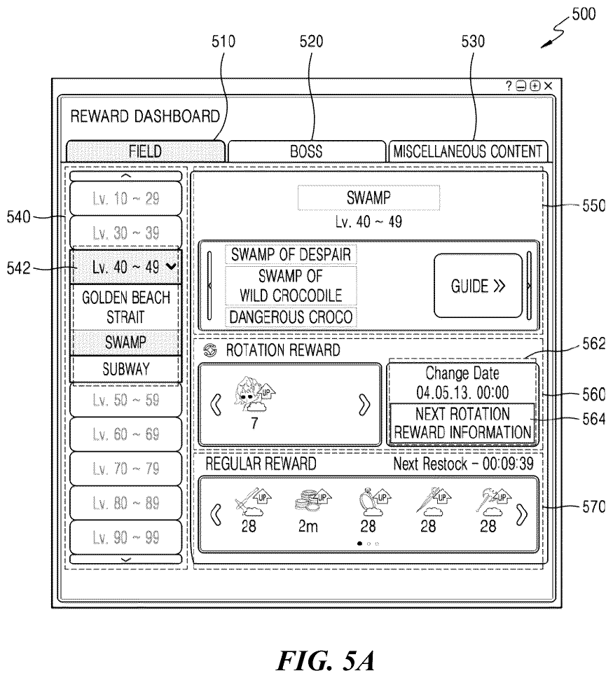

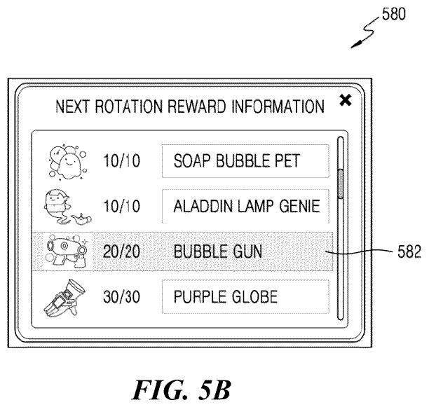

FIG. 5A is a diagram illustrating a reward interface 500 according to an embodiment.

FIG. 5A illustrates a screen on which the reward interface 500 is displayed in a game providing apparatus. The reward interface 500 may be an interface provided when the game providing apparatus obtains a user input related to a reward. The game providing apparatus may provide the reward interface 500 in response to obtaining the user input for entering a shortcut key for the reward interface 500. A method by which a game providing apparatus provides the reward interface 500 is not limited to the disclosed example, and when a user input for the reward interface is identified, the reward interface 500 including information related to field hunting may be provided.

In an embodiment, the reward interface 500 may include at least one of a field interface 510, a boss interface 520, a miscellaneous content interface 530, a level range interface 540, a field information interface 550, a rotational reward interface 560, or a regular reward interface 570. The reward interface 500 is not limited to the example of FIG. 5A, and may further include different components from the components shown in FIG. 5A or may not disclose some of the components of FIG. 5A.

In an embodiment, the field interface 510 may be an interface for displaying information related to a reward for field hunting. The reward interface 500 may be an interface displayed when a user input for the field interface 510 is obtained. For example, when the game providing apparatus obtains a user input for the field interface 510, the game providing apparatus may provide the reward interface 500. The game providing apparatus may be preset to a display including at least one of the level range interface 540, the field information interface 550, the rotational reward interface 560, or the regular reward interface 570 of FIG. 5A without user input to the field interface 510 when providing the reward interface 500. It is not limited to the disclosed example.

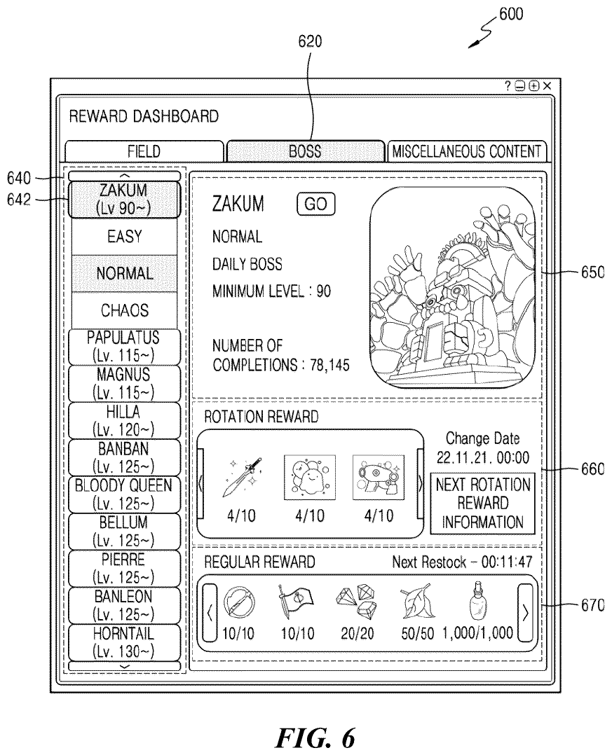

In an embodiment, the boss interface 520 may be an interface for displaying information related to a reward for boss hunting. For example, the game providing apparatus may provide information related to a reward for boss hunting through the reward interface of FIG. 6 based on obtaining a touch input from the user to the boss interface 520. An interface based on a user input for the boss interface 520 is described in detail with reference to FIG. 6.

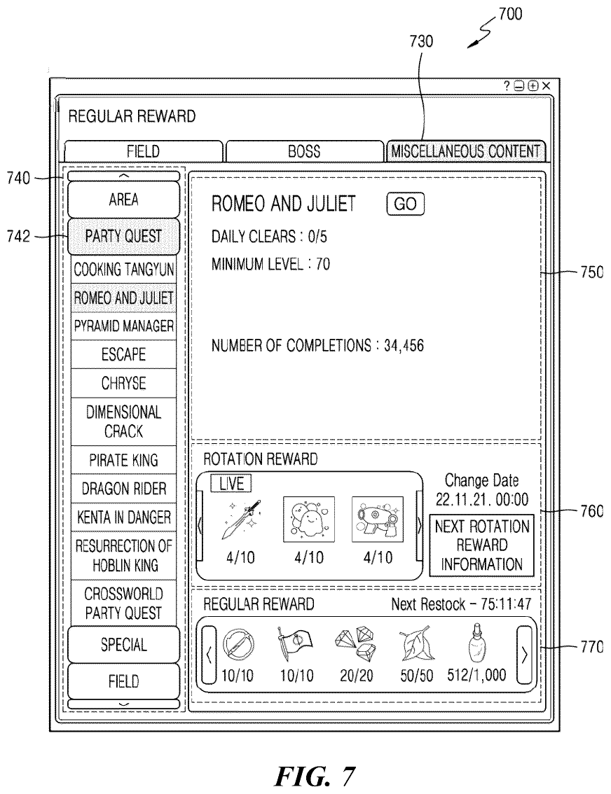

In an embodiment, the miscellaneous content interface 530 may be an interface for displaying information related to a reward for other contents. For example, the game providing apparatus may provide information related to a reward for other contents through the reward interface of FIG. 7 based on obtaining a mouse input from the user to the miscellaneous content interface 530. An interface based on a user input for the miscellaneous content interface 530 is described in detail with reference to FIG. 7. The other contents may refer to content other than field hunting and boss hunting.

Without being limited to the disclosed example, at least one content may be displayed separately in the reward interface.

In an embodiment, the level range interface 540 may be an interface for distinguishing and providing level ranges to recommend a field appropriate for a user level range. The level range interface 540 may be an interface in which one level range appropriate for the user level range is pre-selected from among a plurality of level ranges. For example, the level range interface 540 may be an interface in which levels 40 to 49 are pre-selected and provided when a level of a user is 46. Each level range may be one set of reward layers.

In an embodiment, the level range interface 540 may include a level selection interface 542. The level range interface 540 may obtain or identify a user input for a certain level and provide the level selection interface 542. The level selection interface 542 may be an interface that distinguishes and provides fields depending on a level range and may be an interface for indicating that a certain level range has been selected.

In an embodiment, the level selection interface 542 may provide at least one field based on a certain level being selected. For example, the level selection interface 542 may provide information about fields that do not have background similarity like Golden Beach Strait, Swamp, and Subway but are appropriate for a certain level range. A field appropriate for a certain level range may be a field in which monsters with the same level range as or a small difference with the certain level range are generated. Gold Beach Strait, Swamp, and Subway may each be one reward layer, and Gold Beach Strait, Swamp, and Subway may constitute one set of reward layers.

In an embodiment, the game providing apparatus may provide the field information interface 550 based on obtaining an input for one field provided in the level selection interface 542. When the number of fields provided in the level selection interface 542 is one, the field information interface 550 may be provided based on a user input for one level range.

In an embodiment, the field information interface 550 may be an interface that provides information related to a selected field. For example, the field information interface 550 may include information about at least one map provided in a field selected by a user. The information about the at least one map provided in the field selected by the user may include information about at least one of a name of the map, a location, a method of movement, or a device for movement. Without being limited to the disclosed example, the field information interface 550 may include other information. Each separate field may constitute one reward layer.

In an embodiment, the rotational reward interface 560 may be an interface that provides information about a rotational reward item. The rotational reward interface 560 may include information about at least one of at least rotational reward item, a reward quantity of each rotational reward item, a remaining quantity of each rotational reward item at a current point in time, whether each rotational reward item is minted, whether there was a remaining quantity in a previous reward cycle, information related to a next rotational reward item, a remaining time until the start of a next reward cycle, or a start time of the next reward cycle. The rotational reward item may be a reward item to be provided identically or differently for each reward cycle. For example, the current reward cycle may be the first reward cycle and the next reward cycle may be the second reward cycle. The game providing apparatus may display a remaining time until the end of the first reward cycle.

For example, with regard to the rotational reward item provided in the rotational reward interface 560, the rotational reward item interface may provide information that the rotational reward item is a hair color item of a character, that a remaining quantity for the current reward cycle for the rotational reward item is 7, that the rotational reward item is minted, and that there is a remaining quantity in a previous reward cycle and a reward quantity for the current reward cycle has been determined to be a value greater than a preset basic quantity. For convenience of explanation, an example in which one rotational reward item is used is described, but the disclosure is not limited to the disclosed example.

In an embodiment, the rotational reward interface 560 may include a next reward cycle interface 562. The next reward cycle interface 562 may include information related to a start time of a next reward cycle or a remaining time until the start of the next reward cycle, and at least one rotational reward item for the next reward cycle. The next reward cycle interface 562 may include a next rotation confirmation interface 564 to provide information related to at least one rotational reward item for the next reward cycle.

In an embodiment, the game providing apparatus may provide a next rotational reward information interface 580 of FIG. 5B in response to obtaining an input to the next rotation confirmation interface 564. Hereinafter, the next rotational reward information interface 580 will be described in detail with reference to FIG. 5B.

In an embodiment, the regular reward interface 570 may be an interface that provides information about a regular reward item. The regular reward interface 570 may include information about at least one of at least regular reward item, a reward quantity of each regular reward item, a remaining quantity of each regular reward item at a current point in time, whether each regular reward item is minted, whether there was a remaining quantity in a previous reward cycle, a remaining time until of a next reward cycle, or a start time of the next reward cycle. The regular reward item may be a reward item that is provided in the same way even if the reward cycle changes.

For example, with regard to the regular reward item provided in the regular reward interface 570, the regular reward item interface may provide information that the regular reward item is a two-handed axe, that a remaining quantity for the current reward cycle for the regular reward item is 28, that the regular reward item is minted, and that there is a remaining quantity in a previous reward cycle and a reward quantity for the current reward cycle has been determined to be a value greater than a preset basic quantity. It is not limited to the disclosed example. The game providing apparatus may obtain an input for a field content performing interface indicated by ‘Guide’ and provide guidance for moving to a determined map within a game.

FIG. 5B is a diagram illustrating a reward interface according to an embodiment.

In an embodiment, the game providing apparatus may provide the next rotational reward information interface 580 in response to obtaining an input to the next rotation confirmation interface 564 of FIG. 5A.

In an embodiment, the current reward cycle may be the first reward cycle and the next reward cycle may be the second reward cycle.

In an embodiment, the game providing apparatus may display item information for at least one item provided in the second reward cycle, and quantity information for at least one item provided in the second reward cycle. The game providing apparatus may display item information for the rotational reward item provided in the second reward cycle, and quantity information for the rotational reward item provided in the second reward cycle.

For example, the game providing apparatus may display information that the rotational reward item provided in the second reward cycle includes a soap bubble pet, an Aladdin lamp genie, a bubble gun, and a purple globe and it is possible to provide the items in quantities of 10, 10, 20, and 30, respectively.

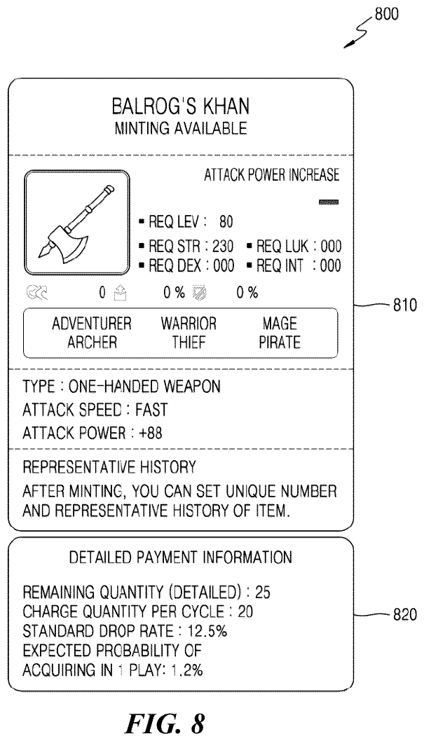

In an embodiment, the game providing apparatus may obtain a user input for an item interface of at least one item provided in the next rotational reward information interface 580 and provide detailed information about an item selected by the user input. For example, the game providing apparatus may provide detailed information about the item selected by the user input as in FIG. 8, which will be described in detail with reference to FIG. 8.

FIG. 6 is a diagram illustrating a reward interface 600 according to an embodiment.

FIG. 6 illustrates a screen on which a reward interface 600 is displayed in a game providing apparatus. The reward interface 600 may be an interface provided when the game providing apparatus obtains a user input related to a reward. The game providing apparatus may provide the reward interface 600 in response to obtaining the user input for entering a touch input to the reward interface 600. A method by which a game providing apparatus provides the reward interface 600 is not limited to the disclosed example, and when a user input for the reward interface is identified, the reward interface 600 including information related to boss hunting may be provided.

In an embodiment, the reward interface 600 may include at least one of a field interface, a boss interface 620, a miscellaneous content interface, a boss name interface 640, a boss information interface 650, a rotational reward interface 660, or a regular reward interface 670. The field interface, miscellaneous content interface, rotational reward interface 660, and regular reward interface 670, which are provided in the reward interface 600, correspond to the field interface 510, miscellaneous content interface 530, rotational reward interface 560, and regular reward interface 570, which are provided in the reward interface 500 of FIG. 5A, respectively, and thus, the same description is omitted.

The reward interface 600 is not limited to the example of FIG. 6, and may further include different components from the components shown in FIG. 6 or may not disclose some of the components of FIG. 6.

In an embodiment, the boss interface 620 may be an interface for displaying information related to a reward for boss hunting. The reward interface 600 may be an interface displayed when a user input for the boss interface 620 is obtained. The game providing apparatus may provide the reward interface 600 when obtaining a user input for the boss interface 620. For example, the game providing apparatus may provide information related to a reward for boss hunting based on obtaining a mouse input to the boss interface 620.

In an embodiment, the boss name interface 640 may be an interface for distinguishing and providing information about at least one boss. The boss name interface 640 may be an interface in which one boss appropriate for a user level is pre-selected from among a plurality of boss names. For example, the boss name interface 640 may be an interface in which, when a user level is 94, a boss monster with a highest level or a most difficult to hunt is pre-selected and provided from among boss monsters that a user is capable of hunting. The game providing apparatus may provide information related to certain boss hunt based on obtaining a user input for a single boss name.

In an embodiment, the boss name interface 640 may include a boss selection interface 642. The boss selection interface 642 may be an interface for indicating that a certain boss monster has been selected based on obtaining a user input for a single boss name. For example, the boss selection interface 642 may be an interface for indicating that ‘Zakum’ has been selected based on obtaining a user input for a boss monster named ‘Zakum’. Each boss monster may be one set of reward layers.

In an embodiment, the boss selection interface 642 may include information about at least one difficulty level for the selected boss monster. For example, the boss selection interface 642 may include information that a difficulty level for boss hunting for a bass called ‘Zakum’ is divided into Easy, Normal, and Chaos (hard). Zakum Easy, Zakum Normal, and Zakum Chaos may each be one reward layer. Boss hunting for ‘Zakum’ may constitute one set of reward layers that includes three reward layers including Zakum Easy, Zakum Normal, and Zakum Chaos.

In an embodiment, the game providing apparatus may provide the boss information interface 650 based on obtaining a user input for one difficulty level for a boss monster provided in the boss selection interface 642. When a difficulty level for a boss monster is one, the boss information interface 650 may be provided even without obtaining a user input regarding the difficulty level.

In an embodiment, the boss information interface 650 may be an interface that provides information related to boss hunting based on a selected boss monster and difficulty level. The boss information interface 650 may include information on at least one of a name of a boss monster, a difficulty level, a possible cycle, a minimum challenge level, or the number of times a certain boss is hunted up to the current point in time, and may provide an interface for performing boss hunting for a selected boss monster. For example, the game providing apparatus may include information that the selected boss monster is Zakum, a medium difficulty level is selected, a minimum challenge level is 90, boss hunting is completed 78,145 times to date, and it is possible to perform boss hunting for Zakum once a day. The game providing apparatus may obtain an input to a boss hunting performing interface marked ‘GO’ and perform boss hunting.

For boss hunting, at least one rotational reward item and regular reward item may be provided, and this has been described in detail with reference to FIGS. 5A and 5B, and thus the same description is omitted.

FIG. 7 is a diagram illustrating a reward interface 600 according to an embodiment.

FIG. 7 illustrates a screen on which a reward interface 700 is displayed in a game providing apparatus. The reward interface 700 may be an interface provided when the game providing apparatus obtains a user input related to a reward. The game providing apparatus may provide the reward interface 700 in response to obtaining a user input of a voice for the reward interface 700. A method by which a game providing apparatus provides the reward interface 700 is not limited to the disclosed example, and when a user input for the reward interface is identified, the reward interface 700 including information related to boss hunting may be provided.

In an embodiment, the reward interface 700 may include at least one of a field interface, a boss interface, a miscellaneous content interface 730, a content name interface 740, a content information interface 750, a rotational reward interface 760, or a regular reward interface 770. The field interface, boss interface, rotational reward interface 760, and regular reward interface 770, which are provided in the reward interface 700, correspond to the field interface 510, boss interface 520, rotational reward interface 560, and regular reward interface 570, which are provided in the reward interface 500 of FIG. 5A, respectively, and thus, the same description is omitted.

The reward interface 700 is not limited to the example of FIG. 7, and may further include different components from the components shown in FIG. 7 or may not disclose some of the components of FIG. 7.

In an embodiment, the miscellaneous content interface 730 may be an interface for displaying information related to a reward for other contents other than field hunting and boss hunting. The reward interface 700 may be an interface displayed when a user input for the miscellaneous content interface 730 is obtained. The game providing apparatus may provide the reward interface 700 when obtaining a user input for the miscellaneous content interface 730. For example, the game providing apparatus may provide information related to a reward for other contents based on obtaining a mouse input to the miscellaneous content interface 730.

In an embodiment, the content name interface 740 may be an interface for distinguishing and providing information about at least one content. The content name interface 740 may be an interface in which one of the most performed content by a user is pre-selected from among a plurality of content names. For example, the other content name interface 740 may be an interface in which a party quest is pre-selected when a user performs the most party quests. The game providing apparatus may provide information related to certain content based on obtaining a user input for a single content name.

In an embodiment, the content name interface 740 may include a content selection interface 742. The content selection interface 742 may be an interface for indicating that certain content has been selected based on obtaining a user input for a single content name. For example, the content selection interface 742 may be an interface for indicating that other content called ‘Party Quest’ has been selected based on obtaining a user input for other content called ‘Party Quest’. Each of other contents may be one reward layer. For example, an area quest, a party quest, a special quest, and a dynamic field may each be a set of reward layers.

In an embodiment, the content selection interface 742 may include information about at least one detailed content for the selected content. For example, the content selection interface 742 may include information that the party quest is divided into detailed contents such as Cooking Tangyun, Romeo and Juliet, Pyramid Manager, Escape, and Chryse. Cooking Tangyun, Romeo and Juliet, Pyramid Manager, Escape, and Chryse, which are provided in the party quest, may each be a reward layer.

In an embodiment, the game providing apparatus may provide the content information interface 750 based on obtaining an input for one detailed content provided in the content selection interface 742. Without being limited to the disclosed example, other contents according to the disclosure are each content that is performed relatively less frequently and may constitute one reward layer.

In an embodiment, the content information interface 750 may be an interface that provides information related to a selected detailed content. The content information interface 750 may include information about at least one of a name of a detailed content, a maximum number of challenges per day, a minimum challenge level, a possible cycle, a difficulty level, or the number of times a certain boss has been hunted up to the current point in time. For example, the game providing apparatus may include information that the selected detailed content is Romeo and Juliet, the minimum challenge level is 70, and content has been performed 34,456 times to date. The game providing apparatus may obtain an input to another content performing interface marked ‘GO’ and perform boss hunting.

For other contents, at least one rotational reward item and regular reward item may be provided, and this has been described in detail with reference to FIGS. 5A and 6, and thus the same description is omitted.

FIG. 8 is a diagram for explaining an operation of providing detailed information about an item according to an embodiment.

In an embodiment, the game providing apparatus may provide detailed information about an item based on obtaining or identifying a user input for an item. For example, the game providing apparatus may identify a mouse over a first item and display detailed information about the mouse-over first item.

In an embodiment, the game providing apparatus may provide detailed information about a first item provided in the reward interfaces 500, 600, and 700) of FIG. 5, FIG. 6, or FIG. 7.

In an embodiment, the game providing apparatus may provide basic information 810 about a first item. The game providing apparatus may display information about at least one of a wearable level, wearable occupation, type, performance, history, or mintability of the first item. For example, the game providing apparatus may display information that ‘Balrog's Khan’ has a wearable level of 80, is capable of being worn by a warrior, is a one-handed weapon, has performance to increase attack power by 88, and is capable of being minted.

In an embodiment, the game providing apparatus may provide reward information 820 about a first item. The game providing apparatus may obtain information about at least one of a remaining quantity for the current reward cycle of the first item, a reward quantity for a next reward cycle, a basic quantity for a reward cycle, or an expected obtaining probability for the current reward cycle. For example, the game providing apparatus may include information that the remaining quantity for the current reward cycle of the ‘Khan of Balrog’ item is 25, the basic quantity for the reward cycle is 20, and the expected obtaining probability when playing once is 1.2%.

In an embodiment, the game providing apparatus may reduce negative experiences with a game, such as reducing visibility or increasing user rejection by exposing excessive information at a glance by providing corresponding information through an additional user input instead of including the basic information 810 and reward information 820 of an item in the reward interfaces 500, 600, and 700 of FIG. 5, FIG. 6, or FIG. 7.

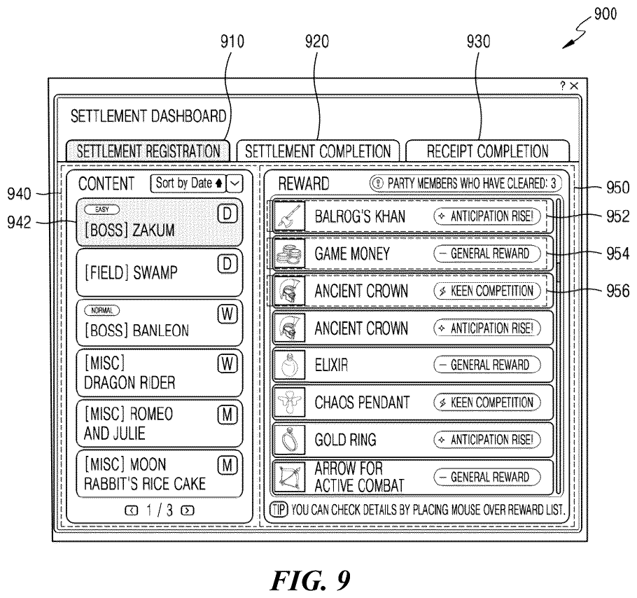

FIG. 9 is a diagram illustrating a settlement interface 900 according to an embodiment.

FIG. 9 illustrates a screen on which the settlement interface 900 is displayed in a game providing apparatus. The settlement interface 900 may be an interface provided when the game providing apparatus obtains a user input related to a settlement. The settlement interface 900 of FIG. 9 may be an interface related to determining at least one user who is to be provided with a reward item from among users who perform content at or after the end of the reward cycle. The end point of the reward cycle or after the end point of the reward cycle may indicate a settlement time for at least one reward item provided for a certain reward cycle.

In an embodiment, the settlement interface 900 may include at least one of a settlement registration interface 910, a settlement completion interface 920, a receipt completion interface 930, a content list interface 940, or a reward item interface 950. The settlement interface 900 is not limited to the example of FIG. 9, and may further include different components from the components shown in FIG. 9 or may not disclose some of the components of FIG. 9.

In an embodiment, the settlement registration interface 910 may be an interface for displaying information related to content and a reward when obtaining an authority for a reward for the content and expecting to obtain at least one reward item at a settlement time. The settlement interface 900 may be an interface displayed when a user input for the settlement registration interface 910 is obtained. For example, when obtaining or identifying a user input for the settlement registration interface 910, the game providing apparatus may provide or display the settlement interface 900. When providing or displaying the settlement interface 900, the game providing apparatus may be preset to include at least one of the content list interface 940 or the reward item interface 950 of FIG. 9 without a user input for the settlement registration interface 910.

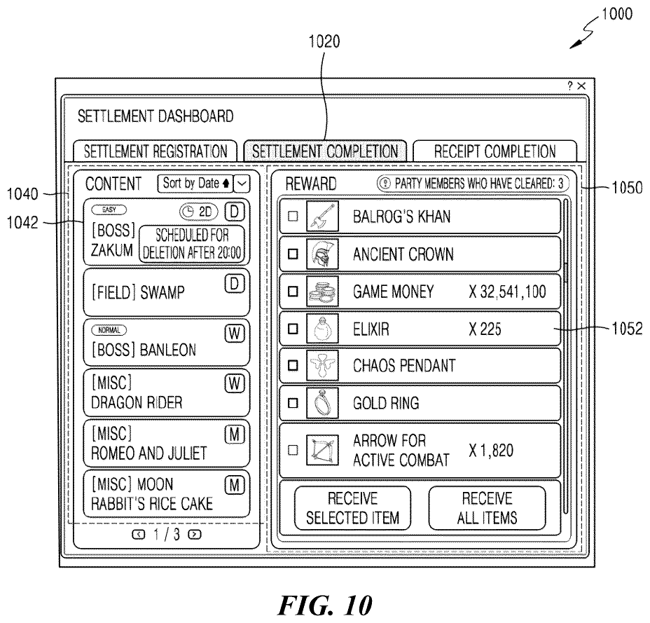

In an embodiment, the settlement completion interface 920 may be an interface for displaying information related to the content and reward when the content is completely settled and a reward item is to be received from among contents provided in the content list interface 940 in the settlement registration interface 910. An interface based on a user input for the settlement completion interface 920 is described in detail with reference to FIG. 10.

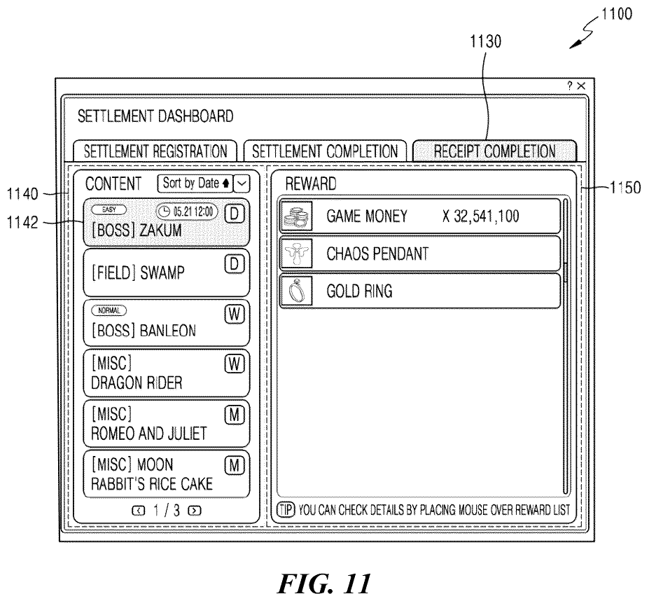

In an embodiment, the receipt completion interface 930 may be an interface for displaying information related to the content and reward when the completely settled reward item is received from among contents provided in a content list interface 940 in a settlement completion interface. An interface based on a user input for the receipt completion interface 930 is described in detail with reference to FIG. 11.

In an embodiment, the content list interface 940 may be an interface that displays information about at least one content for which an authority for at least one reward item is obtained when the user obtains the authority for the at least one reward item by performing the content. The content list interface 940 may include information about at least one content for which the authority for at least one reward item is obtained. For example, the content list interface 940 may include information about at least one of a name, difficulty level, performance cycle, or performance completion time of at least one content for which the authorization is obtained.

In an embodiment, the game providing apparatus may provide the user with an authority for at least one reward item for the content when there is only one user who performs the content.

In an embodiment, the game providing apparatus may distribute authorities for at least one reward item for content to a plurality of users when there are the plurality of users who perform the content. For example, the game providing apparatus may grant an authority for at least one reward item to all of a plurality of users who perform the content. Alternatively, the game providing apparatus may allow only some of the plurality of users to have an authority to at least one reward item, thereby allowing the plurality of users who perform the content to have individual authorities to respective reward items.

In an embodiment, the game providing apparatus may obtain or identify a user input for one content 942 provided in the content list interface 940 and provide or display the reward item interface 950.

In an embodiment, the reward item interface 950 may be an interface that provides information about at least one reward item for which an authorization is obtained. The reward item interface 950 may provide at least one of a name of at least one reward item, information related to an expected obtaining probability, basic information, or reward information for at least one reward item for which an authority is obtained. For example, the reward item interface 950 may display the phrase ‘increased expectation’ for an item with a high expected obtaining probability on an interface of a corresponding item, and may display the phrase ‘keen competition’ on an interface of the corresponding item with a low expected obtaining probability. Without being limited to the disclosed example, the game providing apparatus may provide information related to the expected obtaining probability in other methods.

In an embodiment, the reward item interface 950 may include a first expected item 952, a second expected item 954, and a third expected item 956, which are authorized reward items. The game providing apparatus may display the phrase ‘increased expectation’ for the first expected item together with the number of users granted an authority for the first expected item 952, when the number of users is less than or not significantly different from a reward quantity or remaining quantity for the current reward cycle. The game providing apparatus may display the phrase ‘keen competition’ for the third expected item together with the number of users granted an authority for the third expected item 956 when the number of users is significantly greater than the reward quantity or remaining quantity for the current reward cycle. The game providing apparatus may display a reward item provided to all users who perform content as a regular reward with the phrase ‘General Reward’.

FIG. 10 is a diagram illustrating a settlement interface 1000 according to an embodiment.

FIG. 10 illustrates a screen on which the settlement interface 1000 is displayed in a game providing apparatus. The settlement interface 1000 may be an interface provided when the game providing apparatus obtains a user input related to a settlement. The settlement interface 1000 of FIG. 10 may be an interface that displays information related to the completely settled content and reward when the content is completely settled and a reward item is to be received.

In an embodiment, the settlement interface 1000 may include at least one of a settlement registration interface, a settlement completion interface 1020, a receipt completion interface, a content list interface 1040, or a reward item interface 1050. The settlement interface 1000 is not limited to the example of FIG. 10, and may further include different components from the components shown in FIG. 10 or may not disclose some of the components of FIG. 10. The settlement registration interface, settlement completion interface 1020, and receipt completion interface, which are provided in the settlement interface 1000, correspond to the settlement registration interface 910, settlement completion interface 920, and receipt completion interface 930, which are provided in the settlement interface 900 of FIG. 9, respectively, and thus the same description is omitted.

In an embodiment, the settlement completion interface 1020 may be an interface for displaying information related to the completely settled content and reward when the settlement of a reward for the content is completed and at least one reward item is distributed to the user. The settlement interface 1000 may be an interface displayed when a user input for the settlement completion interface 1020 is obtained. For example, when obtaining or identifying a user input for the settlement completion interface 1020, the game providing apparatus may provide or display the settlement completion interface 1000. When providing or displaying the settlement interface 1000, the game providing apparatus may be preset to provide information including at least one of the content list interface 1040 or the reward item interface 1050 of FIG. 10 without a user input for the settlement completion interface 1020.

In an embodiment, the content list interface 1040 may be an interface that displays information about at least one completely settled content. For example, the content list interface 1040 may include information about at least one of a name, difficulty level, performance cycle, performance completion time, or receipt deadline of the completely settled content. For example, the game providing apparatus may provide information that it is not possible to receive a reward item after 20 hours as information about one content 1042 provided in the content list interface 1040.

In an embodiment, the game providing apparatus may obtain or identify a user input for one content 1042 provided in the content list interface 1040 and provide or display the reward item interface 1050.

In an embodiment, the reward item interface 1050 may be an interface that provides information about at least one reward item that is completely settled and is to be received. The reward item interface 1050 may provide information related to at least one reward item distributed through a settlement. The reward item interface 1050 may provide at least one of a name, number, basic information, or reward information of at least one settled reward item. For example, the reward item interface 1050 may provide information that a name of a first settlement item 1052 is Elixir and that 255 thereof are settled.

In an embodiment, the reward item interface 1050 may include a selection item receipt interface that allows a user to select a portion of at least one settled reward item and receive only some of the reward items, and an all item receipt interface that allows the user to receive all of at least one settled reward item.

FIG. 11 is a diagram illustrating a settlement interface 1100 according to an embodiment.

FIG. 11 illustrates a screen on which the settlement interface 1100 is displayed in a game providing apparatus. The settlement interface 1100 may be an interface provided when the game providing apparatus obtains a user input related to a settlement. The settlement interface 1100 of FIG. 11 may be an interface that displays information related to the completely received content and reward when the completely settled item is received.

In an embodiment, the settlement interface 1100 may include at least one of a settlement registration interface, a settlement completion interface, a receipt completion interface 1130, a content list interface 1140, or a reward item interface 1150. The settlement interface 1100 is not limited to the example of FIG. 11, and may further include different components from the components shown in FIG. 11 or may not disclose some of the components of FIG. 11. The settlement registration interface, settlement completion interface, and receipt completion interface 1130, which are provided in the settlement interface 1100, correspond to the settlement registration interface 910, settlement completion interface 920, and receipt completion interface 930, which are provided in the settlement interface 900 of FIG. 9, respectively, and thus the same description is omitted.

In an embodiment, the receipt completion interface 1130 may be an interface for displaying information related to the completely received content and reward when a reward of the completely settled content is completely received and a user receives at least one reward item. The settlement interface 1100 may be an interface displayed when a user input for the receipt completion interface 1130 is obtained. For example, when obtaining or identifying a user input for the receipt completion interface, the game providing apparatus may provide or display the settlement interface 1100. When providing or displaying the settlement interface 1100, the game providing apparatus may be preset to provide information including at least one of the content list interface 1140 or the reward item interface 1150 of FIG. 11 without a user input for the receipt completion interface 1130.

In an embodiment, the content list interface 1140 may be an interface that displays information about at least one completely received content. For example, the content list interface 1140 may include information about at least one of a name, difficulty level, performance cycle, performance completion time, or receipt completion time of the completely received content. For example, the game providing apparatus may include information that a reward item for content was received at 12:00 on May 21 as information about one content 1142 provided in the content list interface 1140.

In an embodiment, the game providing apparatus may obtain or identify a user input for the one content 1142 provided in the content list interface 1140 and provide or display the reward item interface 1150.

In an embodiment, the reward item interface 1150 may be an interface that provides information about at least one completely received reward item. The reward item interface 1150 may provide information related to at least one received reward item. The reward item interface 1150 may provide at least one of a name, number, basic information, or reward information of at least one received reward item.

In an embodiment, the reward item interface 1150 may include information about only some of the received items when only some of the at least one reward item settled in the settlement interface 1000 of FIG. 10 is selected and received.

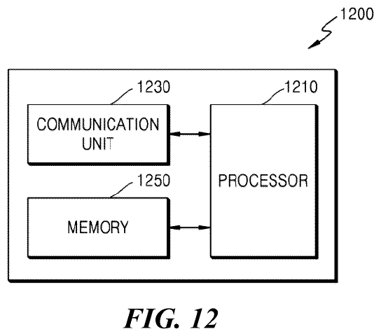

FIG. 12 is a diagram for explaining a detailed configuration of a game providing apparatus according to an embodiment.

As illustrated in FIG. 12, a game providing apparatus 1200 according to some embodiments may include at least one processor 1210 (hereinafter, processor), a communication unit 1230, and memory 1250. However, not all of the components illustrated in FIG. 12 are required components of the game providing apparatus 1200. The game providing apparatus 1200 may be implemented with more components than the components illustrated in FIG. 12, or the game providing apparatus 1200 may be implemented with fewer components than the components illustrated in FIG. 12. The game providing apparatus 1200 may be a user terminal, a server, a game network system, or a separate device.

According to an embodiment, the processor 1210 may typically control the overall operation of the game providing apparatus 1200. For example, the processor 1210 may be configured to execute a program stored in the memory 1250 to generally control the communication unit 1230, the memory 1250, and the like. The processor 1210 may be configured to control the communication unit 1230, the memory 1250, and the like to control an operation of the game providing apparatus 1200 in the specification. The program stored in memory may be instructions for the operation of the game providing apparatus.

According to an embodiment, the processor 1210 may be configured to determine the first reward quantity representing the quantity of the first item that is to be provided in the first reward cycle for content within a game service. The processor 1210 may be configured to determine the second reward quantity representing the quantity of the first item that is to be provided in the second reward cycle for content based on the first reward quantity and the quantity of the first item provided in the first reward cycle. The processor 1210 may be configured to provide the first item in the second reward cycle for the content, depending on the second reward quantity.

According to an embodiment, the processor 1210 may be configured to execute instructions to determine a second reward quantity as a value obtained by adding a first remaining quantity representing a difference between a first reward quantity and a first payment quantity to a preset basic quantity for providing a first item in a second reward cycle when the first payment quantity representing a quantity of the first item provided in the first reward cycle is less than the first reward quantity.

According to an embodiment, the processor 1210 may be configured to execute instructions to determine a second item different from the first item, as an item to be provided in a third reward cycle for the content.

According to an embodiment, the processor 1210 may be configured to execute instructions to stop providing the first item from a certain point in time until the end of the second reward cycle when the second reward quantity is exhausted at a certain point in time within the second reward cycle.

According to an embodiment, the processor 1210 may be configured to execute instructions to provide information about a remaining time of an auction for a game item when an auction end time for the game item has not yet passed.

According to an embodiment, the processor 1210 may execute instructions to determine at least one user who is to be provided with the first item from among users who perform the content at the end of the second reward cycle.

According to an embodiment, the processor 1210 may be configured to execute instructions to display item information for at least one item provided in the second reward cycle and quantity information for at least one item provided in the second reward cycle.

According to an embodiment, the processor 1210 may be configured to execute instructions to display a remaining time until the end of the first reward cycle.

In an embodiment, the communication unit 1230 may perform communication with an external device under control of the processor 1210. For example, the communication unit 1230 may perform communication with an external device such as a payment server or an authentication server under control of the processor 1210. The communication unit 1230 may obtain user information or user input through communication with an external interface.

In an embodiment, the memory 1250 may store a program for processing and controlling the processor 1210 and may also store data input to or output from the game providing apparatus 1200. According to an embodiment, the memory 1250 may store auction information, auction time information, and information related to a game item according to the disclosure.

According to an embodiment, the processor 1210 may execute a method of providing a game service by using a program stored in the memory 1250. For example, the processor 1210 may determine a first reward quantity indicating a quantity of a first item that is to be in the first reward cycle for content within a game service based on at least one piece of information stored in the memory 1250. The processor 1210 may determine the second reward quantity representing the quantity of the first item that is to be provided in the second reward cycle for content based on at least one piece of information stored in the memory 1250, based on the first reward quantity and the quantity of the first item provided in the first reward cycle. The processor 1210 may provide the first item in the second reward cycle for content depending on the second reward quantity based on at least one piece of information stored in the memory 1250.

According to an embodiment, the memory 1250 may include at least one type of storage medium from among a flash memory type, a hard disk type, a multimedia card micro type, a card type memory (e.g., an SD or XD memory), random access memory (RAM), static random access Memory (SRAM), read-only memory (ROM), electrically erasable programmable read-only memory (EEPROM), programmable read-only memory (PROM), a magnetic memory, a magnetic disk, or an optical disk. According to an embodiment, programs stored in the memory 1250 may be classified into a plurality of modules according to their functions.

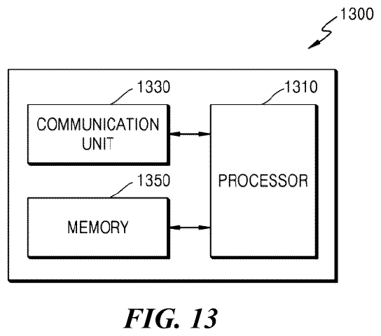

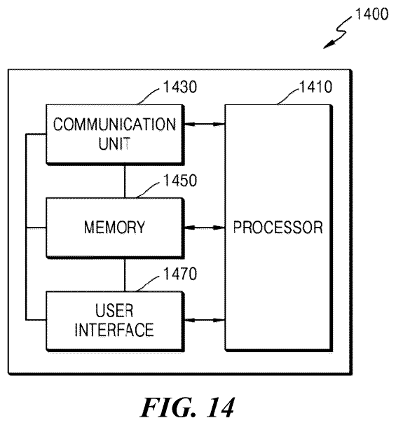

According to an embodiment, a method of providing a game service may be performed by the game providing apparatus 1200, or may be performed by a server or a user terminal, and at least one component provided in the game providing apparatus 1200 may perform the embodiments described with reference to FIGS. 1 to 11 above. The method of providing a game service may be performed individually or collectively by the server and the user terminal. The configuration of the server and user terminal is described in more detail with reference to FIGS. 13 and 14 below.

FIG. 13 is a diagram for explaining a detailed configuration of a server 1300 according to an embodiment.

As illustrated in FIG. 13, the server 1300 according to some embodiments may include at least one processor 1310, a communication unit 1330, and memory 1350. However, not all of the components illustrated in FIG. 13 are required components of the server 1300. The server 1300 may be implemented with more components than the components illustrated in FIG. 13, or the server 1300 may be implemented with fewer components than the components illustrated in FIG. 13.

According to an embodiment, the processor 1310 may typically control the overall operation of the server 1300. For example, the processor 1310 may be configured to execute a program stored in the memory 1350 to generally control the communication unit 1330, the memory 1350, and the like. The processor 1310 may be configured to control the communication unit 1330, the memory 1350, and the like to control an operation of the server 1300 in the specification.

According to an embodiment, the processor 1310 may determine the first reward quantity representing the quantity of the first item that is to be provided in the first reward cycle for content within a game service. The processor 1310 may determine the second reward quantity representing the quantity of the first item that is to be provided in the second reward cycle for content based on the first reward quantity and the quantity of the first item provided in the first reward cycle. The processor 1310 may provide the first item in the second reward cycle for the content, depending on the second reward quantity.

According to an embodiment, an operation of the processor 1310 may correspond to the operation of the processor 1210 of the game providing apparatus 1200 described with reference to FIG. 12, and therefore, a detailed description is omitted.

The communication unit 1330 may provide a query to a user terminal 1400 under control of the processor 1310 and receive response information to the query. According to an embodiment, the communication unit 1330 may transmit and receive data with the user terminal 1400, and the data transmitted and received with the user terminal 1400 may include control data for controlling the user terminal 1400 or a program provided in the user terminal 1400.

The memory 1350 may store a program for processing and controlling the processor 1310 and may also store data input to or output from the server 1300. According to an embodiment, the memory 1350 may store at least one piece of information to be stored in the memory 1250 of the game providing apparatus 1200 of FIG. 12.

According to an embodiment, the processor 1310 may be configured to execute a method of providing a game service by using a program stored in the memory 1350.

According to an embodiment, the memory 1350 may include at least one type of storage medium from among a flash memory type, a hard disk type, a multimedia card micro type, a card type memory (e.g., an SD or XD memory), random access memory (RAM), static random access Memory (SRAM), read-only memory (ROM), electrically erasable programmable read-only memory (EEPROM), programmable read-only memory (PROM), a magnetic memory, a magnetic disk, or an optical disk. According to an embodiment, programs stored in the memory 1350 may be classified into a plurality of modules according to their functions.

According to an embodiment, a game providing method may be performed separately by the server 1300 and the user terminal 1400, may be performed individually by the server 1300 and the user terminal 1400, or may be performed by the game providing apparatus 1200.

FIG. 14 is a diagram for explaining a detailed configuration of a user terminal 1400 according to various embodiments.

As illustrated in FIG. 14, the user terminal 1400 according to some embodiments may include at least one processor 1410, a communication unit 1430, memory 1450, and a user interface 1470. However, not all of the components illustrated in FIG. 14 are required components of the user terminal 1400. The user terminal 1400 may be implemented with more components than the components illustrated in FIG. 14, or the user terminal 1400 may be implemented with fewer components than the components illustrated in FIG. 14.

According to an embodiment, the processor 1410 may typically control the overall operation of the user terminal 1400. For example, the processor 1410 may be configured to execute a program stored in the memory 1450 to generally control the communication unit 1430, the memory 1450, the user interface 1470, and the like. The processor 1410 may be configured to control the communication unit 1430, the memory 1450, the user interface 1470, and the like to control the operation of the user terminal 1400 in the specification.

According to an embodiment, the processor 1410 may determine the first reward quantity representing the quantity of the first item that is to be provided in the first reward cycle for content within a game service. The processor 1410 may determine the second reward quantity representing the quantity of the first item that is to be provided in the second reward cycle for content based on the first reward quantity and the quantity of the first item provided in the first reward cycle. The processor 1410 may provide the first item in the second reward cycle for the content, depending on the second reward quantity.

According to an embodiment, an operation of the processor 1410 may correspond to the operation of the processor 1210 of the game providing apparatus 1200 described with reference to FIG. 12, and therefore, a detailed description is omitted.

The communication unit 1430 may provide a query to the server 1300 under control of the processor 1410 and receive response information to the query. According to an embodiment, the communication unit 1430 may transmit and receive data with the server 1300, and the data transmitted and received with the server 1300 may include control data for controlling the user terminal 1400 or a program provided in the user terminal 1400.

According to an embodiment, the communication unit 1430 may include, but is not limited to, a Bluetooth communication unit, a Bluetooth low energy (BLE) communication unit, a near field communication unit, a WLAN (Wi-Fi) communication unit, a Zigbee communication unit, an infrared (infrared data association (IrDA)) communication unit, a Wi-Fi direct (WFD) communication unit, an ultra-wideband (UWB) communication unit, and an Ant+ communication unit.

According to an embodiment, the communication unit 1430 transmits and receives a wireless signal with at least one of a base station, an external terminal, or a server on a mobile communication network. Here, the wireless signal may include various forms of data according to transmission and reception of a voice call signal, a video call signal, or a text/multimedia message.

The memory 1450 may store a program for processing and controlling the processor 1410 and may also store data input to or output from the user terminal 1400. According to an embodiment, the memory 1450 may store information regarding a game service. For example, the memory 1450 may store at least one piece of information to be stored in the memory 1250 of the game providing apparatus of FIG. 12.

According to an embodiment, the processor 1410 may be configured to execute a method of providing a game service by using a program stored in the memory 1450.

According to an embodiment, the memory 1450 may include at least one type of storage medium from among a flash memory type, a hard disk type, a multimedia card micro type, a card type memory (e.g., an SD or XD memory), random access memory (RAM), static random access Memory (SRAM), read-only memory (ROM), electrically erasable programmable read-only memory (EEPROM), programmable read-only memory (PROM), a magnetic memory, a magnetic disk, or an optical disk. According to an embodiment, programs stored in the memory 1450 may be classified into a plurality of modules according to their functions.

According to an embodiment, the user interface 1470 may include various interfaces. For example, the user interface 1470 may include various interfaces such as a key pad, a dome switch, a voice input interface, a fingerprint input interface, a touch input interface (contact electrostatic capacitance type, pressure resistive film type, infrared detection type, surface ultrasonic conduction type, integral tension measurement type, or piezo effect type), a camera, a jog wheel, and a jog switch, and various sensors such as an acceleration sensor, a position sensor, a temperature sensor, and a light sensor may be linked to the user interface. It may not be limited to the example.

According to an embodiment, the user interface 1470 may further include an output unit (not shown). The output unit may include at least one of a liquid crystal display, a thin film transistor-liquid crystal display, an organic light-emitting diode, a flexible display, a 3D display, or an electrophoretic display. When a display and a touchpad are configured in a layered structure to form a touch screen, the display may be used as an input device in addition to an output device. The output unit (not shown) may include a light emitting diode (LED) lamp, a vibration motor, a speaker, and a flash but is not limited to the example.

According to an embodiment, the user interface 1470 may output a notification about game information in the form of an image, video, sound, vibration, lamp, and the like.

According to an embodiment, the user interface 1470 may include at least one of the reward interface 500, the field interface 510, the boss interface 520, the miscellaneous content interface 530, the level range interface 540, the field information interface 550, the rotational reward interface 560, or the regular reward interface 570 of FIG. 5A.

According to an embodiment, the user interface 1470 may include at least one of the reward interface 600, the field interface, the boss interface 620, the miscellaneous content interface, the boss name interface 640, the boss information interface 650, the rotational reward interface 660, or the regular reward interface 670 as in an embodiment of FIG. 6.

According to an embodiment, the user interface 1470 may include at least one of the reward interface 700, the field interface, the boss interface, the miscellaneous content interface 730, the content name interface 740, the content information interface 750, the rotational reward interface 760, or the regular reward interface 770 of FIG. 7.

According to an embodiment, the user interface 1470 may include at least one of the settlement interface 900, the settlement registration interface 910, the settlement completion interface 920, the receipt completion interface 930, the content list interface 940, or the reward item interface 950 of FIG. 9.

According to an embodiment, the user interface 1470 may include at least one of the settlement interface 1000, the settlement registration interface, the settlement completion interface 1020, the receipt completion interface, the content list interface 1040, or the reward item interface 1050 of FIG. 10.

According to an embodiment, in the user interface 1470, the settlement interface 1100 of FIG. 11 may include the settlement registration interface, the settlement completion interface, the receipt completion interface 1130, the content list interface 1140, and the reward item interface 1150, but the interfaces are only described as examples of the user interface 1470, and the user interface 1470 of the disclosure may include more diverse interfaces as components.

The device described above may be implemented as a hardware component, a software component, and/or a combination of the hardware component and the software component. For example, the device and component described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor, or any other device capable of executing instructions and responding. A processing device may execute an operating system (OS) and one or more software applications executed on the OS. The processing device may access, store, manipulate, process, and generate data in response to execution of software. For ease of understanding, the processing device is sometimes described as being used alone, but those of skill in the art will recognize that the processing device may include a plurality of processing elements and/or a plurality of types of processing elements. For example, the processing device may include a plurality of processors or one processor and one controller. Alternatively, the processing device may include other processing configurations, such as a parallel processor.

Software may include a computer program, code, instruction, or a combination of one or more of these, which may configure a processing device to perform a desired operation or may independently or collectively command the processing device. The software and/or data may be permanently or temporarily embodied in any type of machine, component, physical device, virtual equipment, computer storage media or device, or transmitted signal waves, for interpretation by a processing device or for providing instructions or data to the processing device. The software may be distributed on a network connected computer system and stored or executed in a distributed manner. The software and data may be stored on one or more computer-readable recording media.

The method according to an embodiment may be implemented in the form of program commands that are to be executed through various computer devices and recorded on a computer-readable medium. The computer-readable medium may include a program instruction, a data file, and a data structure alone or in combination. The program instruction recorded on the medium may be specially designed and configured for an embodiment or may be known and available to those of skill in the art of computer software. Examples of computer-readable recording media include magnetic media such as hard disks, floppy disks, and magnetic tape, optical media such as CD-ROMs and DVDs, magneto-optical media such as floptical disks, and hardware devices specifically configured to store and execute program instructions, such as ROM, RAM, and flash memory. Examples of program instructions include machine language code generated by a compiler, as well as high-level language code executable by a computer using an interpreter and the like. The hardware device may be configured to operate as one or more software modules to perform the operation according to an embodiment, and vice versa.

Although the embodiments have been described above by way of limited examples and drawings, those of skill in the art will appreciate that various modifications and variations may be made from the above description. For example, appropriate results may be obtained even if the given descriptions are performed in a different order than described, and/or components of the described systems, structures, devices, circuits, and the like are combined or combined in a different manner than described, or are replaced or substituted by other components or equivalents.

Therefore, other implementations, other embodiments, and equivalents to the claims are also included in the scope of the claims described below.

In an embodiment, when the game providing apparatus provides a reward stack, an expected reward increases the sooner the content is cleared, and thus a player desire to grow may be stimulated, and even for content that is not highly preferred, a player desire to perform the content may be stimulated by rewards accumulating over time, thereby naturally obtaining an effect of activating various contents.

In an embodiment, when the game providing apparatus provides reward rotation, some of rewards placed in content are continuously changed, and thus attractiveness of each content felt by a player may change, thereby providing new fun to the player and obtaining an effect of activating various contents.

In an embodiment, the game providing apparatus may further maximize a player desire to grow and perform content by varying a settlement time for the content depending on the characteristics of the content. For example, for content that has no limit on the number of participations or content cost, the player may be rewarded immediately after performing the content, thereby providing an immediate reward to the player and motivating the player to continue perform the content. Alternatively, for content with a limited number of participations, the content may be settled at the end of the reward cycle or within a certain time after the end of the reward cycle, thereby encouraging many players to participate in the content up to the maximum number of participations.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing a game service by a game providing apparatus, the method comprising:
determining a first reward quantity representing a quantity of a first item to be provided in a first reward cycle for content within the game service;
determining a second reward quantity representing a quantity of the first item to be provided in a second reward cycle for the content based on the first reward quantity and a quantity of the first item provided in the first reward cycle; and
providing the first item in the second reward cycle for the content based on the second reward quantity.

2. The method of claim 1, wherein the determining of the second reward quantity includes:
when a first payment quantity representing the quantity of the first item provided in the first reward cycle is less than the first reward quantity, determining the second reward quantity as a value obtained by adding a first remaining quantity representing a difference between the first reward quantity and the first payment quantity to a preset basic quantity for providing the first item in the second reward cycle.

3. The method of claim 1, further comprising:
determining a second item different from the first item, as an item to be provided in a third reward cycle for the content.

4. The method of claim 1, wherein the providing of the first item in the second reward cycle includes:
when the second reward quantity is exhausted at a certain point in time within the second reward cycle, stopping the providing of the first item from the certain point in time to an end of the second reward cycle.

5. The method of claim 1, wherein the providing of the first item in the second reward cycle includes:
determining at least one user who is to be provided with the first item from among users who perform the content at an end of the second reward cycle.

6. The method of claim 3, wherein the first item or the second item is a non-fungible token (NFT).

7. The method of claim 1, further comprising:
displaying item information for at least one item to be provided in the second reward cycle, and quantity information for the at least one item to be provided in the second reward cycle.

8. The method of claim 1, wherein the content is provided in a unit of any one of a map, a reward layer, and a set of reward layers.

9. The method of claim 1, wherein the content includes at least one of field hunting, a dynamic field, boss hunting, an area quest, a party quest, or a growth quest.

10. The method of claim 1, wherein a total quantity of the first item provided within the game service is preset, and the preset total quantity of the first item is unchangeable.

11. The method of claim 1, further comprising:
displaying a remaining time until an end of the first reward cycle.

12. A game providing apparatus comprising:
memory storing instructions; and
at least one processor functionally connected to the memory and configured to execute the instructions,
wherein the at least one processor is configured to execute the instructions to:
determine a first reward quantity representing a quantity of a first item to be provided in a first reward cycle for content within a game service,
determine a second reward quantity representing a quantity of the first item to be provided in a second reward cycle for the content based on the first reward quantity and a quantity of the first item provided in the first reward cycle, and
provide the first item in the second reward cycle for the content based on the second reward quantity.

13. The game providing apparatus of claim 12, wherein the at least one processor is configured to execute the instructions to:
when a first payment quantity representing the quantity of the first item provided in the first reward cycle is less than the first reward quantity, determine the second reward quantity as a value obtained by adding a first remaining quantity representing a difference between the first reward quantity and the first payment quantity to a preset basic quantity for providing the first item in the second reward cycle.

14. The game providing apparatus of claim 12, wherein the at least one processor is configured to execute the instructions to:
determine a second item different from the first item, as an item to be provided in a third reward cycle for the content.

15. The game providing apparatus of claim 12, wherein the at least one processor is configured to execute the instructions to:
when the first reward quantity is exhausted at a certain point in time within the first reward cycle, stop providing the first item from the certain point in time to an end of the first reward cycle.

16. The game providing apparatus of claim 12, wherein the at least one processor is configured to execute the instructions to:
determine at least one user who is to be provided with the first item from among users who perform the content at an end of the second reward cycle.

17. The game providing apparatus of claim 14, wherein the first item or the second item is a non-fungible token (NFT).

18. The game providing apparatus of claim 12, wherein the at least one processor is configured to execute the instructions to:
display item information for at least one item to be provided in the second reward cycle, and quantity information for the at least one item to be provided in the second reward cycle.

19. The game providing apparatus of claim 12, wherein the content is provided in a unit of any one of a map, a reward layer, and a set of reward layers.

20. A non-transitory computer-readable recording medium having recorded thereon a program for performing, on a computer, a method of providing a game service, the method comprising:
determining a first reward quantity representing a quantity of a first item to be provided in a first reward cycle for content within the game service;
determining a second reward quantity representing a quantity of the first item to be provided in a second reward cycle for the content based on the first reward quantity and a quantity of the first item provided in the first reward cycle; and
providing the first item in the second reward cycle for the content based on the second reward quantity.
